(19) United States
(12) Patent Application Publication
(10) Pub. No.: US 2004/0250293 A1
(43) Pub. Date: Dec. 9, 2004

(54) System and method for providing alternate program services

(75) Inventors: Kim Annon Ryal, Poway, CA (US); Arman Nikzad, Escondido, CA (US)

Correspondence Address: ROGITZ & ASSOCIATES, Suite 3120, 750 B Street, San Diego, CA, 92101, US

(73) Assignees: SONY CORPORATION, Tokyo (JP); SONY ELECTRONICS INC., Park Ridge, NJ (US)

(21) Appl. No.: 10/457,234

(22) Filed: Jun. 9, 2003

(51) Int. Cl. H04N 7/16; G06F 13/00; H04N 5/445; G06F 3/00; H04N 7/08

(52) U.S. Cl. 725/135; 725/136; 348/473

(57) ABSTRACT

Portions of a single channel can be received from two separate sources and combined for simultaneous display. Thus, for example, a channel with video stream and two different language streams might be received from a TV transponder, but the viewer might elect to receive a third language stream from, e.g., the Internet. The third language stream is combined with the video. By providing an alternate source for additional channel portions, broadcast bandwidth can be conserved.

### BACKGROUND OF THE INVENTION

1. Field of the Invention

The present invention relates generally to television systems.

2. Description of the Related Art

Televisions and computers have become ubiquitous, and since both usually entail a visual display, efforts have been made to integrate both functions into a single system. In this way, a consumer need not purchase and operate two separate systems, which can burden some consumers who, while familiar with operating a television and its remote control, might not be familiar with operating, e.g., an Internet computer.

To the extent that attempts have been made to combine television with Internet features, it has generally been with the focus of producing what might be thought of as a “lean forward” system. That is, hybrid TV/computers have typically been more oriented toward productivity, generally thought of as a computer system characteristic, and less toward entertainment (“lean back”), generally regarded as a television system characteristic. With the above-mentioned critical observation of the present invention in mind, it can readily be appreciated that the differences between a system designed for “lean forward” experiences and a system designed for “lean back” experiences can be both subtle and profound.

In the above context, the present invention recognizes that in one aspect of a lean-back experience, it is desirable that a viewer be able to surf both TV channels and Web sites using a TV remote control device. It is further desirable that the presentation appear to be seamless to the viewer, that is, that a Web site appear as a channel on the TV, and have the same attributes as TV channels, including features such as rating and lock-out of a channel based on the rating for particular viewers. Moreover, it is sometimes the case that the TV signal provider will change the channel number associated with a particular station, and it is desirable that in the context of providing Web page channels, the channel number that is associated with a Web page is not hard-wired but rather can be changed in the same manner as a TV channel. Indeed, the present invention more broadly recognizes that TV channel metaphors be provided not only for Web pages but for virtually any service, such as TV system set up services, game services, and so on.

As further recognized herein, however, while various channels may be provided from different sources, currently all portions of a single channel come from the same source, either broadcast, or Internet, or other source. This can have its drawbacks. As but example, in the case of broadcast channels, the program provider might wish to enable a viewer to pick a desired language to accompany the video, but since all portions of the channel come from the same source, the number of languages carried in the channel stream is necessarily limited by bandwidth to perhaps only two selections. With this in mind, the invention disclosed below has been provided.

### SUMMARY OF THE INVENTION

A television system includes a processor that receives plural channels from a primary source, and that also receives portions of one or more channels from an alternate source. The portion of a channel received from the alternate source is combined with channel data from the primary source for simultaneous display of the two portions. If desired, the processor can be disposed in a set top box.

In a particularly preferred embodiment, the processor accesses a data structure correlating both the portion from the alternate source and the channel data from the primary source with a single channel. The preferred non-limiting data structure may use MPEG technology and may include program map tables (PMT), one for each channel, that correlate packet identifier numbers (PIDs) with respective sources. The data structure may further include a program allocation table (PAT) correlating PMTs with respective channels. In a non-limiting embodiment the PAT may have a predetermined PID such as but not limited to zero.

In an illustrative embodiment, the primary source is a first TV transponder and the alternate source can be the Internet, or a hard disk drive, a home network, or a second TV transponder. Video from the first TV transponder is combined with the portion from the alternate source. The portion from the alternate source can be an audio stream, video data, a data service, an electronic program guide, or an expanded program description. If desired, the portion from the alternate source may be provided in a packetized elementary stream (PES).

In another aspect, a method for providing content related to at least one single channel includes receiving a user selection of portions of a particular channel the user wishes to have displayed, and then accessing the portions from respective primary and alternate sources. At least the primary source is a television transponder. The method includes displaying the portions together.

In still another aspect, a TV system includes a display, a processor presenting content on the display, and a primary source communicating with the processor and providing television content. The system also includes an alternate source communicating with the processor and providing television content. At least one program map table (PMT) corresponding to a single channel identifies content portions related to the single channel, and the PMT correlates at least a first portion with the primary source and at least a second portion with the alternate source. With this invention, the processor uses the PMT to access the sources to simultaneously display the first and second portions.

### BRIEF DESCRIPTION OF THE DRAWINGS

The details of the present invention, both as to its structure and operation, can best be understood in reference to the accompanying drawings, in which like reference numerals refer to like parts, and in which:

FIG. 1 is a block diagram of the system of the present invention;

FIG. 2 is a schematic diagram of an exemplary non-limiting program map table (PMT);

FIG. 3 is a schematic diagram of an exemplary non-limiting program allocation table (PAT); and

FIG. 4 depicts the present logic in non-limiting flow chart format.

### DETAILED DESCRIPTION OF THE PREFERRED EMBODIMENTS

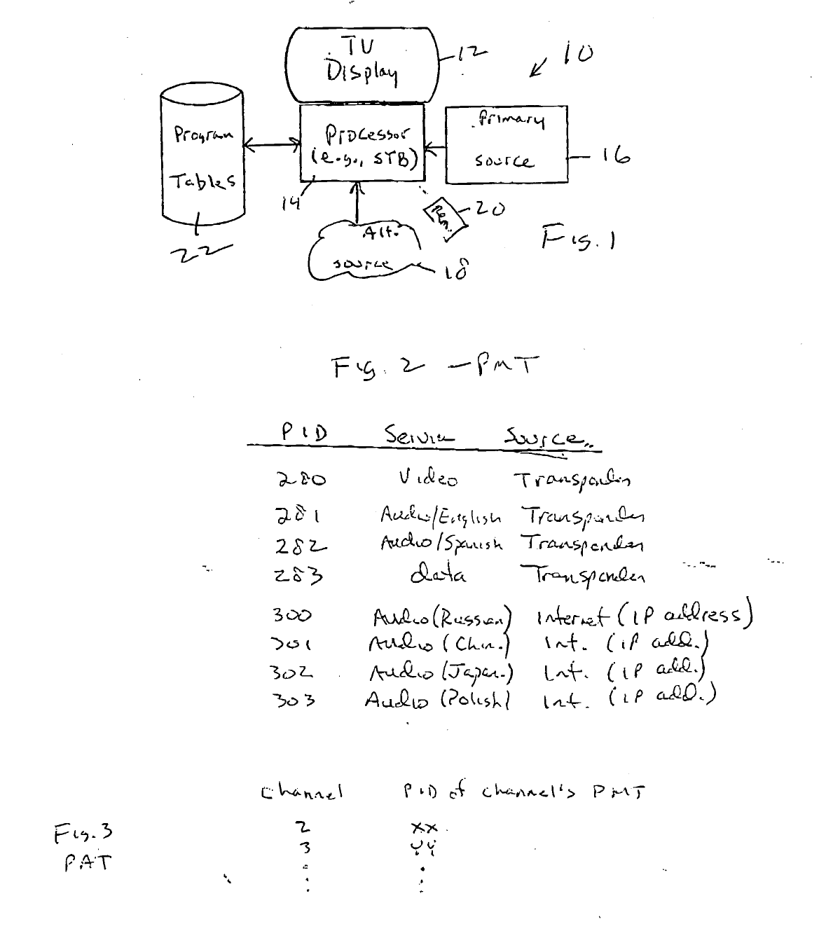

Referring initially to FIG. 1, a television (TV) system is shown, generally designated 10, that includes an audio/video TV display 12 that conventionally receives, potentially through a processor 14 that may be housed in a set-top box, televised content from an antenna, satellite dish, cable, etc. for display of the content. The processor 14 alternatively can be incorporated into the housing of the display 12 to function in accordance with the disclosure herein.

It is to be understood, however, that the term “television” or “television system” encompasses any apparatus that has a television tuner and the below-described capability in a single housing or in separate housings that cooperate together. For instance, the processor 14 alternatively can be incorporated into a personal video recorder (PVR) that functions in accordance with the present invention, or even into a standalone computer such as a PC or laptop with its own monitor (not shown), and can communicate with the display 12 by wired or wireless link or simply by transferring data from the TV to the computer.

In the preferred non-limiting embodiment shown, the processor 14 may access one or more software or hardware elements to undertake the present logic. These elements can include a TV transponder or other primary source 16 for receiving TV station signals from a cable, antenna, or other source as provided by a TV service provider.

As the processor 14 receives a particular channel content from the primary source 16, as set forth further below it may also simultaneously receive content pertaining the same channel from an alternate source 18, such as but not limited to the Internet. Other alternate sources can include a hard disk drive, a home network, and a second TV transponder. More than one alternate source 18 may be provided. In the case wherein the alternate source 18 is the Internet, the processor 14 would access a browser. It is to be understood that greater or fewer software elements can be provided. For instance, the elements discussed above can be integrated together as a single software or hardware module or as separate modules.

Additionally, the processor 14 can include a receiver for conventionally receiving control signals from a portable remote control device 20 that functions in accordance with principles known in the art. It is to be understood that while FIG. 1 shows that the device 20 can be a conventional TV remote control device, less preferably other devices can be used, such as but not limited to keyboards, keypads, mice, touch screen technology, voice activation/recognition technology, etc. Conventional channel, volume, and TV settings buttons (not shown) can also be provided.

The processor 14 executes the logic set forth herein. The flow charts herein illustrate the structure of the logic modules of the present invention as embodied in computer program software. Those skilled in the art will appreciate that the flow charts illustrate the structures of logic elements, such as computer program code elements or electronic logic circuits, that function according to this invention. Manifestly, the invention is practiced in its essential embodiment by a machine component that renders the logic elements in a form that instructs a digital processing apparatus (that is, a computer or microprocessor) to perform a sequence of function steps corresponding to those shown. Internal logic could be as simple as a state machine.

In other words, the present logic may be established as a computer program that is executed by a processor within, e.g., the present microprocessors/servers as a series of computer-executable instructions. In addition to residing on hard disk drives, these instructions may reside, for example, in RAM of the appropriate computer, or the instructions may be stored on magnetic tape, electronic read-only memory, or other appropriate data storage device.

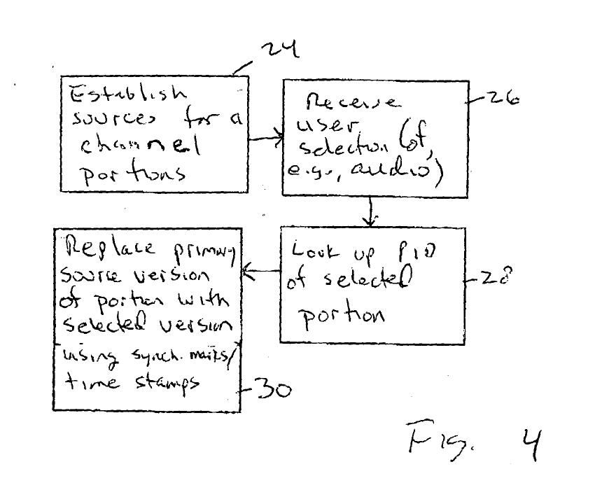

In accordance with the present invention, the processor 14 accesses a data structure 22 that correlates content portions pertaining to a channel received from the primary source 16 with other portions of the same channel received from the alternate source 18. Examples of portions of such a data structure are shown in FIGS. 2 and 3, which show, respectively, a program map table (PMT) for a single channel and a program allocation table (PAT) that correlates channels to the packet identifiers (PIDs) of the respective PMTs associated with the channels. The processor first accesses the PAT of FIG. 3 (which may have as its PID a value of 0), using, as an entering argument in the first column, the selected channel number. It retrieves the PID of that channel's PMT from the second column, and then accesses the appropriate PMT using the corresponding PID. More broadly, the processor 14 accesses the PAT of FIG. 3 to determine which PMT to use for the selected channel, an exemplary one of which is shown in FIG. 2. That is, the PAT correlates PMTs with respective channels.

Once the correct PMT (FIG. 2) for the selected channel is accessed, the processor 14 determines the identities of various portions of the corresponding channel using the first column (“PID”) of the PMT. In a non-limiting embodiment, the various channel portions that are broken down by PID (or PID prefix) may be provided in a packetized elementary stream (PES). If desired, transport streams (multiplexed program streams) can be used and then PID-filtered to extract the individual PES streams.

A second column of FIG. 2 may be provided to indicate the type of service carried by packets that are identified by the PID of the first column. The third column of FIG. 2 then indicates the source of the packets corresponding to the row.

Thus, for instance, packets that include “PID=280” for the channel represented by the PMT of FIG. 2 are video packets from a transponder source. Likewise, English language and Spanish language audio packets (PIDs 281 and 282, respectively) are available from the channel data received from the transponder, as is data (PID=283). On the other hand, Russian, Chinese, Japanese, and Polish language audio streams (respective PIDs 300, 301, 302, 303) that pertain to the channel are available at the corresponding Internet addresses listed for those streams in the third column. In addition to audio streams, the alternate source could carry streams respectively related to, e.g., a data service, an electronic program guide, other video/audio data, and an expanded program description.

Using the data structure 22 discussed above, the processor 14 can execute the logic shown in FIG. 4. The sources discussed above are first established at block 24. The PES streams from the alternate source 18 may be timestamped and/or contain synchronization marks to facilitate merger with the streams from the primary source 16.

At block 26, the processor 14 receives a user selection of which portions of a particular channel the user wishes to have displayed along with the channel number. For example, the user may select “channel 2, Russian language”. At block 28, the portions are accessed from their respective sources 16, 18 using their respective PIDs and combined together (using, e.g., the synchronization marks and/or timestamps) at block 30 for simultaneous display of the portions in an integrated audio-video program on the display 12.

As a non-limiting illustration, the viewer might be presented with a list of languages on the display 12, and if the viewer selects “Russian” using, e.g., the remote control device 20 and then selects the channel corresponding to the PMT of FIG. 2, the processor would access the PMT and from there would access both the primary and alternate sources 16, 18 to combine PID=300 audio Russian language packets from the alternate source 18 (e.g., from the Internet address provided in the PMT) with PID=280 video packets from the primary source 16 (e.g., from the TV transponder). In this case, the audio streams from the primary source 16 have essentially been replaced with an audio stream from the alternate source 18.

To avail himself of the alternate source 18 content, a viewer may purchase a subscription separate from his subscription to the primary source 16. Thus, content from the alternate source 18 may be available only on demand.

In any case, the alternate source data may require transcoding to the proper format or stream structure. For example, if the alternate source is DV video, is might require transcoding to MPEG to be merged with the stream to be played.

While the particular SYSTEM AND METHOD FOR PROVIDING ALTERNATE PROGRAM SERVICES as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular means “at least one”. All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. §112, sixth paragraph, unless the element is expressly recited using the phrase “means for”.

We Claim:

1. A television system, comprising:
a processor configured for receiving plural channels from a primary source, and also configured for receiving, for at least one of the channels received from the primary source, a portion related to the channel from an alternate source, the portion being combined with channel data from the primary source for simultaneous display of the portion from the alternate source with the channel data from the primary source.

2. The system of claim 1, wherein the processor is disposed in a set top box.

3. The system of claim 1, wherein the processor accesses a data structure correlating both the portion from the alternate source and the channel data from the primary source with a single channel.

4. The system of claim 3, wherein the data structure includes at least one program map table (PMT) correlating packet identifier numbers (PIDs) with respective sources.

5. The system of claim 4, wherein the data structure includes at least one program allocation table (PAT) correlating PMTs with respective channels.

6. The system of claim 5, wherein the PAT has PID equal to zero.

7. The system of claim 1, wherein the primary source is a first TV transponder and the alternate source is at least one: the Internet, a hard disk drive, a home network, and a second TV transponder.

8. The system of claim 7, wherein video data from the first TV transponder is combined with the portion from the alternate source, the portion from the alternate source being at least one of: audio data, video data, a data service, an electronic program guide, and an expanded program description, from the alternate source.

9. The system of claim 1, wherein at least the portion from the alternate source is provided in a packetized elementary stream (PES).

10. A method for providing content related to at least one single channel, comprising:
receiving a user selection of portions of a particular channel the user wishes to have displayed;
accessing the portions from respective primary and alternate sources, at least the primary source being a television transponder; and
displaying the portions together.

11. The method of claim 10, wherein the method is executed by a processor accessing a data structure correlating both a portion from the alternate source and a portion from the primary source with a single channel.

12. The method of claim 11, wherein the data structure includes at least one program map table (PMT) correlating packet identifier numbers (PIDs) with respective sources.

13. The method of claim 12, wherein the data structure includes at least one program allocation table (PAT) correlating PMTs with respective channels.

14. The method of claim 10, wherein the alternate source is at least one: the Internet, a hard disk drive, a home network, and a second TV transponder.

15. The method of claim 14, comprising combining video data from the television transponder with a portion from the alternate source, the portion from the alternate source being at least one of: audio data, video data, a data service, an electronic program guide, and an expanded program description, from the alternate source.

16. The method of claim 10, comprising providing at least a portion from the alternate source in a packetized elementary stream (PES).

17. A TV system comprising:
a display;
a processor presenting content on the display, the processor accessing at least a primary source providing television content and at least an alternate source providing television content; and
at least one program map table (PMT) corresponding to a single channel, the PMT identifying content portions related to the single channel, the PMT correlating at least a first portion with the primary source and at least a second portion with the alternate source, wherein
the processor uses the PMT to access the sources to simultaneously display the first and second portions.

18. The system of claim 17, wherein the processor is disposed in a set top box.

19. The system of claim 17, wherein the PMT correlates packet identifier numbers (PIDs) with respective sources.

20. The system of claim 19, comprising at least one program allocation table (PAT) correlating PMTs with respective channels and accessible to the processor.

21. The system of claim 17, wherein the primary source is a first TV transponder and the alternate source is at least one: the Internet, a hard disk drive, a home network, and a second TV transponder.

22. The system of claim 21, wherein the first portion is video data from the first TV transponder, the video data being combined with the second portion from the alternate source, the portion from the alternate source being at least one of: audio data, video data, a data service, an electronic program guide, and an expanded program description, from the alternate source.

23. A system for providing content related to at least one single channel, comprising:
means for receiving a user selection of portions of a particular channel the user wishes to have displayed;
means for accessing the portions from respective primary and alternate sources, at least the primary source being a television transponder; and
means for displaying the portions together.

24. The system of claim 23, wherein the means for accessing uses at least one program map table (PMT) correlating packet identifier numbers (PIDs) with respective sources.

25. The system of claim 24, comprising at least one program allocation table (PAT) correlating PMTs with respective channels.

26. The system of claim 23, wherein the primary source is a first TV transponder and the alternate source is at least one: the Internet, a hard disk drive, a home network, and a second TV transponder.

27. The system of claim 26, wherein video data from the first TV transponder is combined with the portion from the alternate source, the portion from the alternate source being at least one of: audio data, video data, a data service, an electronic program guide, and an expanded program description, from the alternate source.
